(19) United States
(12) Patent Application Publication
(10) Pub. No.: US 2013/0232026 A1
(43) Pub. Date: Sep. 5, 2013

(54) SYSTEM AND METHOD FOR MEASUREMENT BASED DESIGN SELECTION

(71) Applicant: Steven Katzman, Sterling Heights, MI (US)

(72) Inventor: Steven Katzman, Sterling Heights, MI (US)

(21) Appl. No.: 13/767,344

(22) Filed: Feb. 14, 2013

Related U.S. Application Data
(60) Provisional application No. 61/598,422, filed on Feb. 14, 2012.

(51) Int. Cl. G06Q 30/06

(52) U.S. Cl. CPC G06Q 30/0621
USPC 705/26.5

(57) ABSTRACT

A system and method for applications that include a hierarchical selection system enabling efficient user selection of parameters while allowing for continuous progression through selection steps.

### FIELD OF THE INVENTION

The present invention relates to user selection of design and product parameters and to the identification of available products based upon such parameters. In particular, this invention relates to web applications that include a hierarchical selection system enabling efficient user selection of parameters while allowing for continuous progression through selection steps without requiring deletion of non-selected values.

### BACKGROUND OF THE INVENTION

There have been many advances in applications for the selection and purchase of consumer products. There is a particular need for improved applications that simplify the process of home design and the selection and purchase of customized products related to home design. Certain challenges exist in the area of e-commerce relating to interior design due to the lack of standardization within home and business spaces and the resulting need for customized products. As one example, consumers choosing to shop for window treatments through a standard e-commerce site must take significant time and effort to familiarize themselves with the many options that exist depending on the size, functionality and decorative specifications of each particular window within a home or business. Generally, direct interaction with a sales associate is required for such purposes, so that the associate can present a consumer with all available window treatment styles, materials, and options for each window depending on the length, width, location and design of each window. Based upon the size, location, and design of each window for which treatments are desired, the available options differ among manufacturers and are constantly changing depending upon the current stock and offerings of each manufacturer. As such, the knowledge and access to information of a sales representative is often required for a consumer to make an informed purchase decision. It would therefore be beneficial to have access to such detailed information that generally resides only with a sales associate through an e-commerce website.

U.S. Publication No. 2003/0120618 discloses a customer ordering system for window treatments. A hard copy catalog and associated order form are disclosed where the order form includes references back to pages within the catalog for a customer to review descriptions of products that may be available. U.S. Publication No. 2006/0184884 discloses an online interface for the selection of materials for design purposes that allows a user the opportunity to view combinations of materials from various sources via a three-dimensional viewer. The system is directed toward collaborative viewing of room design as opposed to selecting and purchasing specific design items based upon provided measurements and product specifications and availability.

Accordingly, in view of the above, there exists a need for applications that allow a user to provide design parameters for an aspect of a home or business and to identify all available product options that meet those specifications and to select and purchase products that meet those exact design parameters with no need for direct interaction with a sales associate. There is a further need for such applications that allow a user to frequently navigate between a design plan and standard product web pages so that multiple product variations can be added to the design plan for simplified comparison and modification. There is yet a further need for such applications that allow a user to add multiple product variations to a design plan and select any combination of variations for purchase without requiring deletion of non-selected products prior to purchase.

### SUMMARY OF THE INVENTION

The present invention meets some or all of the above needs by providing a process available in a program stored on a non-transitory computer readable medium for selecting window treatments comprising the steps of selecting a design plan worksheet, and accessing a first data entry point, wherein access to a second data entry point is prevented until a location label is provided and a variable corresponding to the location label is provided. The process further includes providing the location label and providing the variable value, wherein the variable value equals the number windows in a location. The process may also include accessing a second data entry point, wherein the second data entry point includes one or more measurement selection zones and the number of measurement selection zones is equal to the variable value. The process may further include selecting values for each of the one or more measurement selection zones wherein each measurement selection zone includes an item identifier, a quantity identifier, a width identifier, a height identifier and a mount identifier. The process may also include a step of accessing a third data entry point, wherein the third data entry point includes one or more product selection zones and the number of product selection zones is equal to the variable value. The process may include selecting values for each of the one or more product selection zones wherein each product selection zone includes a manufacturer identifier, a model identifier, a style identifier, a collection identifier and a color identifier. The process disclosed herein may further include applying the values selected for the one or more product selection zones to any number of variables, wherein additional values for the product selection may be selected in the event that the values selected for the one or more product selection zones are not applied to all variables.

The system herein offers any of a number of benefits and advantages, including but not limited to one or any combination of the following: the system allows for viable combination selection only while preventing the selection of products that are unavailable; the hierarchical nature of the system requires selection of initial values before allowing selection of latter values; the system allows for continued progression through the selection and purchase process without requiring deletion of non-selected product selection; the system allows for simplified navigation between product pages and the worksheet and the selection and comparison of multiple design schemes for each variable.

### BRIEF DESCRIPTION OF THE DRAWINGS

The principles and operation of the system, apparatus, and method according to the present invention may be better understood with reference to the drawings, and the following description, it being understood that these drawings are given for illustrative purposes only and are not meant to be limiting.

FIG. 1 is an illustrative screen-shot in accordance with the present invention.

FIG. 2 is an illustrative screen-shot in accordance with the present invention.

FIG. 3 is an illustrative screen-shot showing the initial selected variables.

FIG. 4 is an illustrative screen-shot showing values selected for the measurement selection zone.

FIG. 5 is an illustrative screen-shot showing a product selection zone.

FIG. 6 is an illustrative screen-shot showing values selected for the product selection zone.

FIG. 7 is an illustrative screen-shot showing the location for selection of options identifiers.

FIG. 8 is an illustrative screen-shot showing the values selected as default values for the options identifiers.

FIG. 9 is an illustrative screen-shot showing the values that may be selected for the options identifiers.

FIG. 10 is an illustrative screen-shot showing panel tabs for review of selected values.

FIG. 11 is an illustrative screen-shot showing the selection of multiple values for the product selection zone.

FIG. 12 is an illustrative screen-shot showing price comparison after the selection of multiple values for the product selection zone.

FIG. 13 is an illustrative screen-shot showing only one set of values selected for the product selection zone for each variable.

FIG. 14 is an illustrative screen-shot showing the addition of a variable after selection of values for the measurement selection zone and product selection zone.

FIG. 15 is an illustrative screen-shot showing a summary of both selected and unselected values for the product selection zone.

FIG. 16 is an illustrative screen-shot showing removal of a value from the product selection zone.

FIG. 17 is an illustrative screen-shot showing the option of copying the entire worksheet or selected variable to a cart location.

FIG. 18 is an illustrative screen-shot showing the selected values for the measurement selection zone, product selection zone and option identifiers remaining on worksheet and also available for viewing in a cart location.

FIG. 19 is an illustrative screen-shot showing an option for selection of additional worksheets.

FIG. 20 is an illustrative screen-shot showing selection of values for the product selection zone during browsing.

FIG. 21 is an illustrative screen-shot showing selection of values for the product selection zone copied from the cart location to a worksheet.

FIG. 22 is an illustrative screen-shot showing an example instructions page to demonstrate use of the worksheet to a user.

### DETAILED DESCRIPTION OF THE INVENTION

The following description is presented to enable one of ordinary skill in the art to make and use the invention as provided in the context of one or more particular applications and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. For example, one or more of the steps described in the methods of the invention may be eliminated and/or replaced. In other instances, well-known methods, procedures, and components have not been described in detail, so as not to obscure the present invention.

The system and methods of the present teachings provide a means for accessing a program stored on a non-transitory computer readable medium that facilitates providing a set of design parameters and identifying, selecting and purchasing available products that conform precisely to the provided design parameters. The hierarchical architecture of the system and process of product selection requires selection of mandatory measurement values to allow for cost comparison and purchase of products. Thus, the teachings contemplate a system, apparatus and process that allows for the entry of values for a measurement selection zone in order to determine available values for a product selection zone. In addition, multiple product selection zone values can be selected for each variable to allow for direct product comparison.

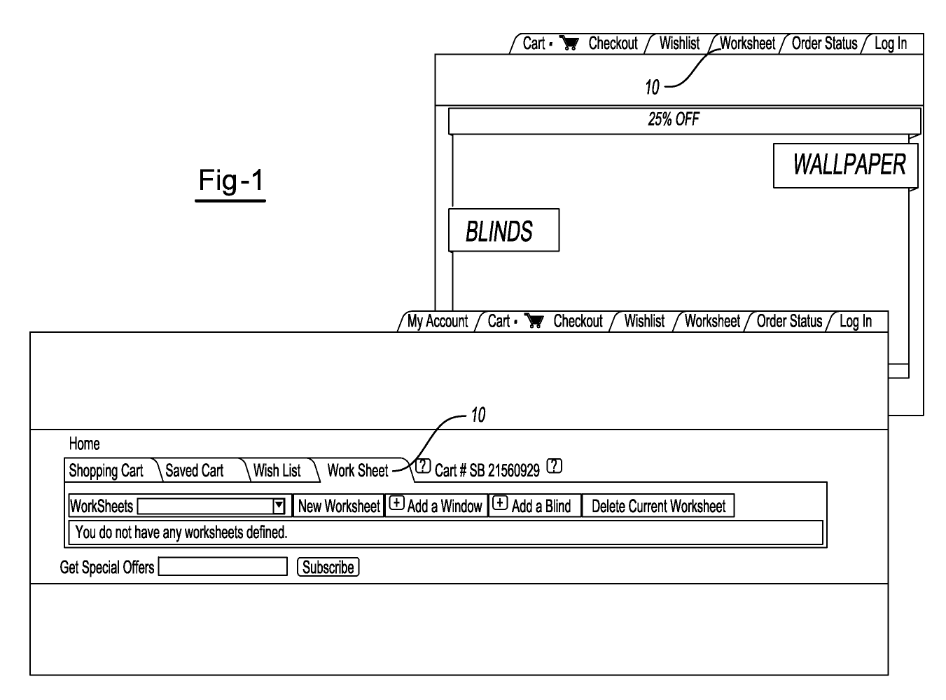

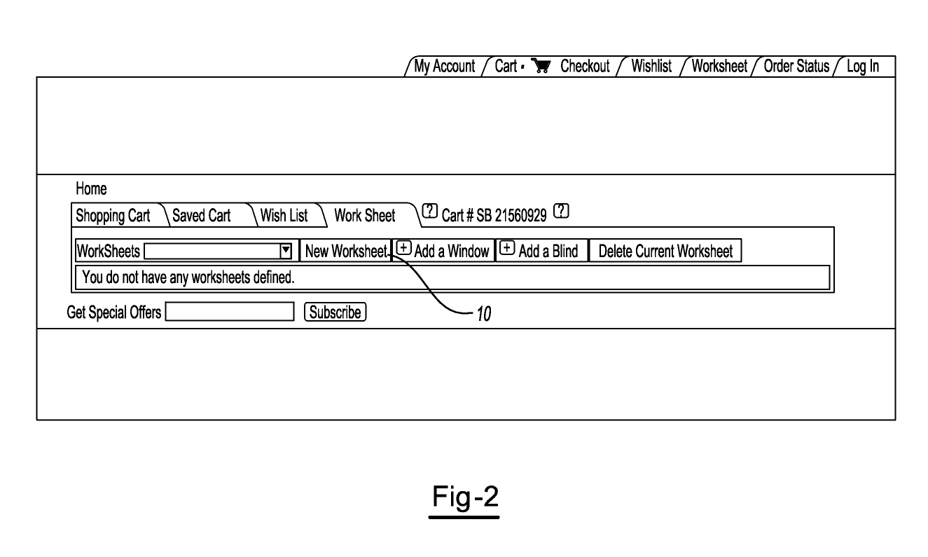

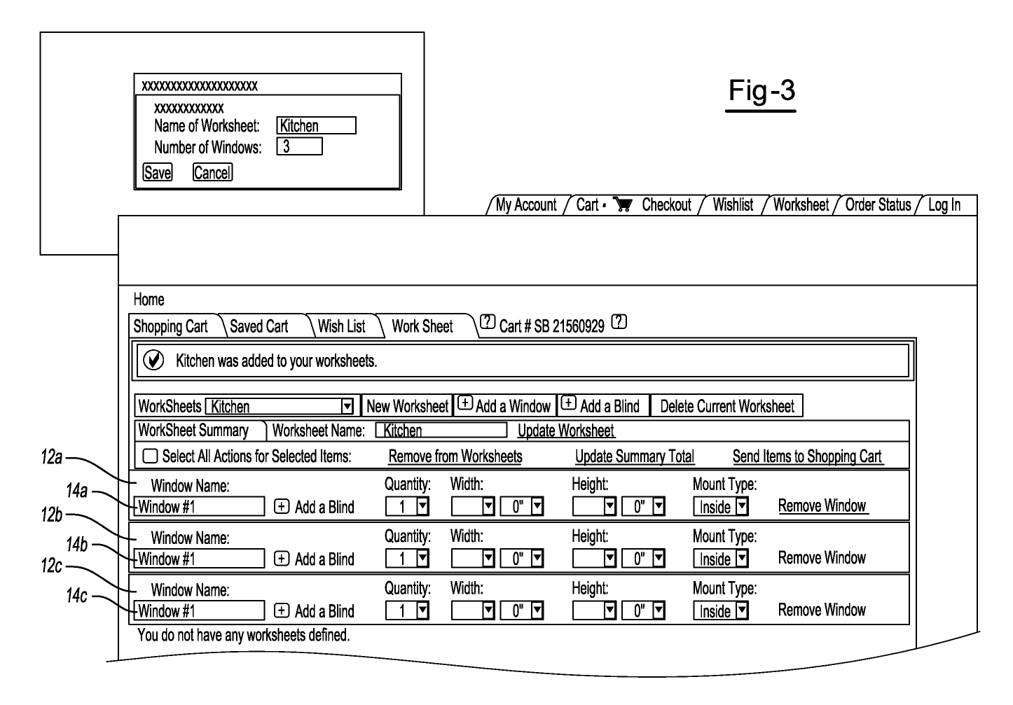

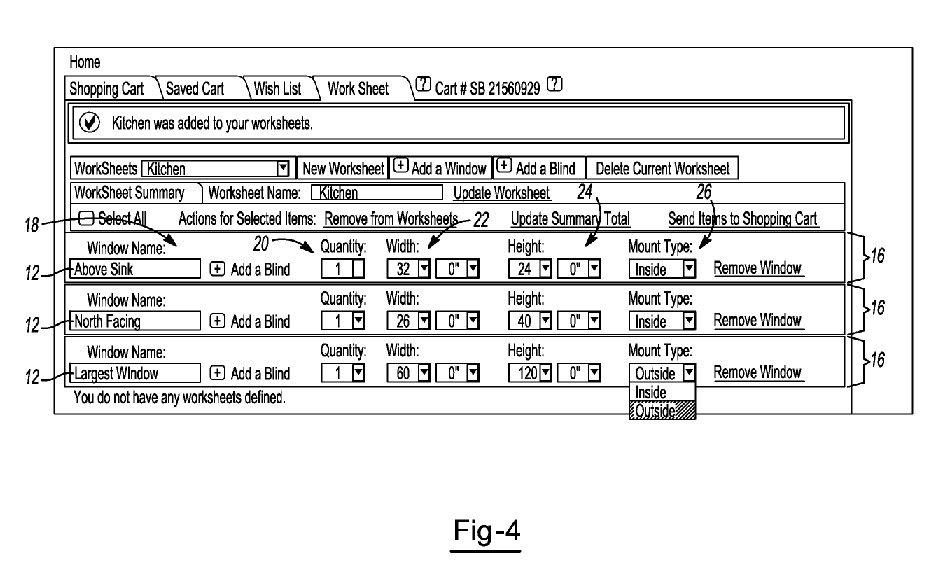

Referring to the drawings, as shown for example in FIGS. 1 and 2, a user (e.g., a consumer, a sales associate, or the like) may access the web-based worksheet (e.g., a form) via a computer as taught herein, by accessing a worksheet link 10 available on an e-commerce website. The worksheet may be available as part of a program stored on a non-transitory computer readable medium. The worksheet may be available as a separate software component which may be downloaded or available without direct internet access. The worksheet link 10 may be available on multiple pages within an e-commerce website. Upon accessing the worksheet, the user may arrive at a first data entry point, where the user may be required to identify an integer value for the number of variables that may require a product selection and purchase. As shown in FIG. 3, the variables 12a, 12b, and 12c identified are the number of windows within a room, in this case three windows. The user may also be required to provide a name or other identifier for the worksheet. The system may require that the name or other identifier be unique, such that an error message may appear in the event that a name or other identifier is repeated. In FIG. 3, the worksheet is labeled as “Kitchen”. The three windows may receive default labels 14a, 14b, and 14c as shown in FIG. 3 where they are labeled as window #1, window #2, and window #3. The user may also provide custom labels to each variable. For example, as shown in FIG. 4, the variables 12 are labeled according to location or size.

Each variable 12 may include a measurement selection zone 16 (e.g., a second data entry point). The user may be prevented from entering values for the measurement selection zones until one or more values have been entered for the first data entry point. More specifically, one or more values for the first data entry point (for example, a value for the number of variables) may be required before values can be selected for any latter data entry points. An exemplary measurement selection zone 16 is shown at FIG. 4. Accordingly, an exemplary measurement selection zone 16 may include a plurality of fields relating to product size. The measurement selection zone shown at FIG. 4 includes an item identifier 18, a quantity identifier 20, a width identifier 22, a height identifier 24, and a mount identifier 26. The item identifier 18 may identify each variable and may include a default label as shown in FIG. 3, or may include customized labels as shown in FIG. 4. The quantity identifier 20 allows for selection of multiple products for a variable (which may represent multiple variables having identical values for one or more of the width identifier, height identifier and mount identifier). The width identifier 22 includes a means for identifying or selecting the width of a variable. The exemplary width identifiers 22 shown at FIG. 4 include a drop-down menu to designate the width in feet and inches of each window listed as a variable 12. The height identifier 24 includes a means for identifying or selecting the height of a variable. The exemplary height identifiers 24 shown at FIG. 4 include a drop-down menu to designate the height in feet and inches of each window listed as a variable 12. The mount identifier 26 includes a means for identifying or selecting the location of the mount of a variable. The exemplary mount identifiers 26 shown at FIG. 4 include a drop-down menu to designate the type of mount available for each window listed as a variable 12.

Upon selection of values for the measurement selection zones 16, values may then be selected for the product selection zone 28 (e.g., the third data entry point). As mentioned above, the user may be prevented from entering values for the product selection zone until one or more values have been entered for the measurement selection zone. In one embodiment, the user may be prevented from entering values for the product selection zone until all values have been entered for the measurement selection zone. More specifically, one or more values for the measurement selection zone (for example, values for one or more of the item identifier, the quantity identifier, the width identifier, the height identifier, and the mount identifier) may be required before values can be selected for the product selection zone. Alternatively, in the event that no values are provided for the measurement selection zone, the product selection zone may still be available and values may be entered for the product selection zone, but no price will be shown and availability of the product will be unknown given that no measurement selection zone values were provided.

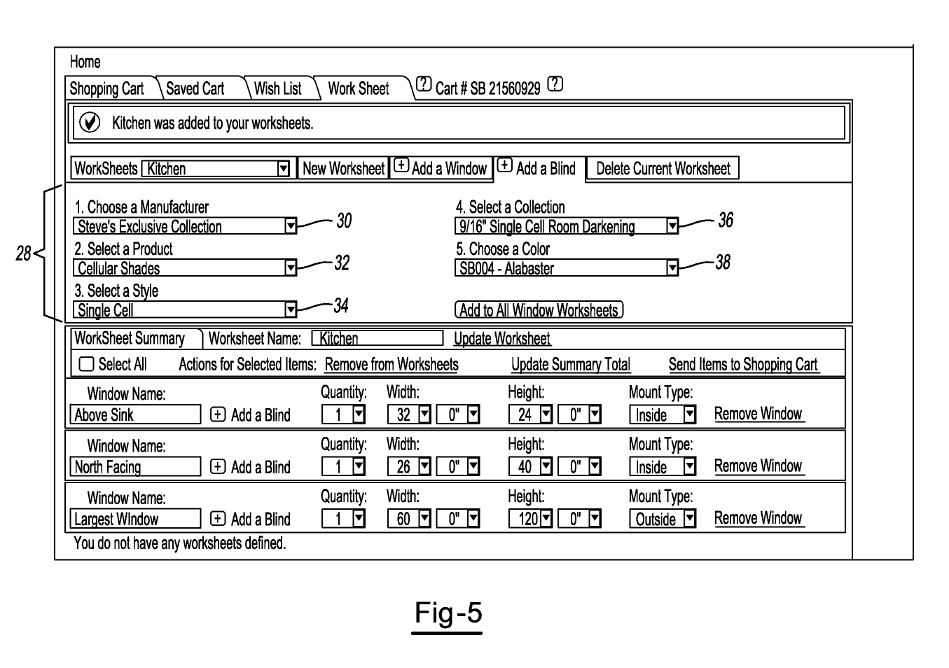

Each variable may include a product selection zone 28 (e.g., a third data entry point). An exemplary product selection zone 28 is shown at FIG. 5. The product selection zone may be accessed as shown in FIG. 5 by adding values to the entire worksheet, such that all variables will be assigned the same values for the product selection zone. Alternatively, the product selection zone may be accessed via each individual variable such that distinct values for the product selection zone may be selected for each variable.

Accordingly, an exemplary product selection zone 28 may include a plurality of fields relating to product design specifications. The product selection zone shown at FIG. 5 includes a manufacturer identifier 30, a product identifier 32, a style identifier 34, a collection identifier 36, and a color identifier 38. The manufacturer identifier 30 may include a drop-down menu containing a list of manufacturers from whom products may be purchased. This list may or may not be limited by the values provided for the measurement selection zone. As an example, if a particularly large value is provided for the width identifier, not all manufacturers may provide products having that width so that the list of available manufacturers may include only those manufacturers who produce products having that value provided for the width identifier. Alternatively, all manufacturers may be available for selection, but upon selection of values for the remaining identifiers of the product selection zone, a warning message will indicate the unavailability of the selected product having the selected value for the width identifier. The product identifier 32 may include a drop-down menu that includes a list of products available from the selected manufacturer. In the event that no value is selected for the manufacturer identifier, the drop-down menu for the product identifier may contain no values for selection. The style identifier 34 may include a drop-down menu that includes a list of styles available for the selected product. In the event that no value is selected for the manufacturer identifier, or no value is selected for the product identifier, the drop-down menu for the style identifier may contain no values for selection. The collection identifier 36 may include a drop-down menu that includes a list of collections available within the selected style. In the event that no value is selected for one or more of the manufacturer identifier, the product identifier, or the style identifier, the drop-down menu for the collection identifier may contain no values for selection. The color identifier 38 may include a drop-down menu that includes a list of colors available for the selected collection. In the event that no value is selected for one or more of the manufacturer identifier, the product identifier, the style identifier, or the collection identifier the drop-down menu for the color identifier may contain no values for selection. Upon selection of values for each of the manufacturer identifier, product identifier, style identifier, collection identifier and color identifier, the values may be added to all variables or less than all variables.

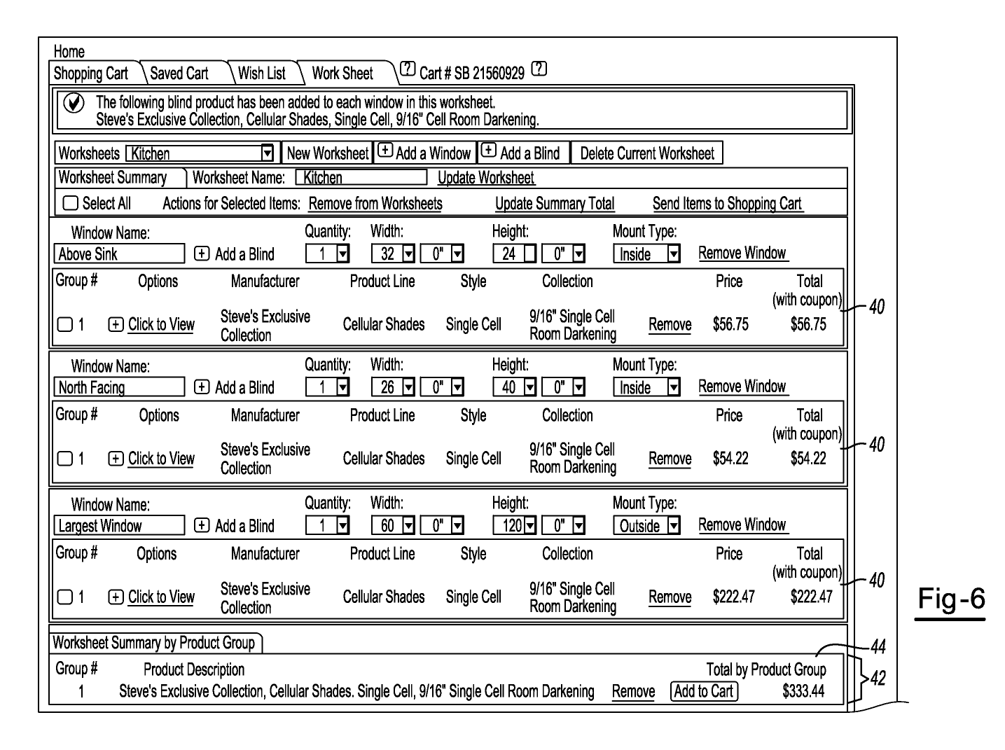

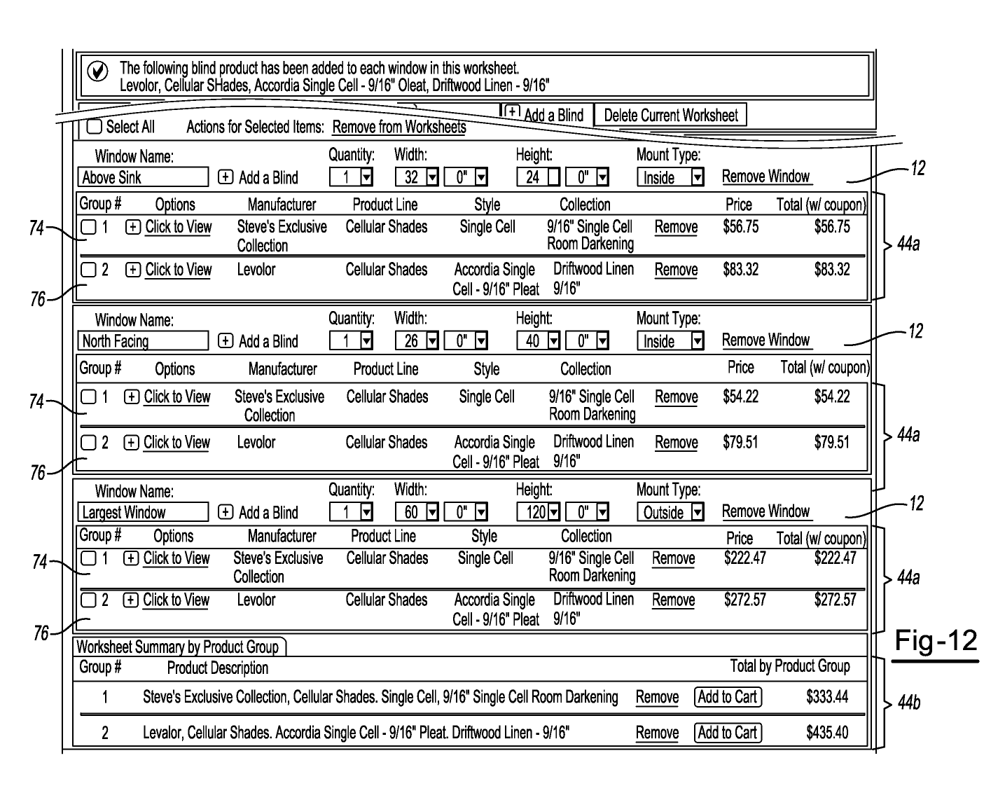

As shown in FIG. 6, upon addition of identical values for the product selection zone for all variables, the product details 40 of the selected values may appear beneath each variable. In addition, a product group summary 42 will include a cost estimate 44 for those values selected in the product selection zone and assigned to each variable. As shown specifically at FIG. 6, the product group summary 42 may categorize each set of values selected in the product selection zone so that a user may select multiple differing values for the product selection zone while viewing cost estimates for each set of values. This will be discussed in detail with reference to FIG. 12.

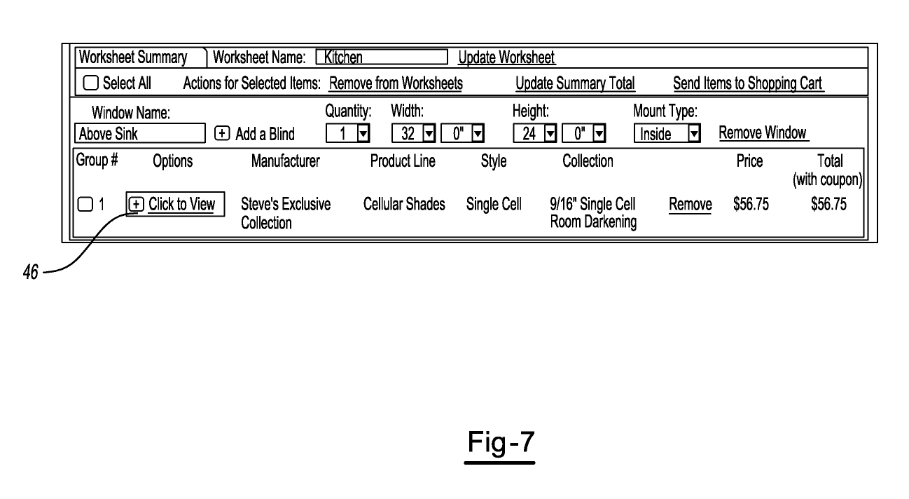

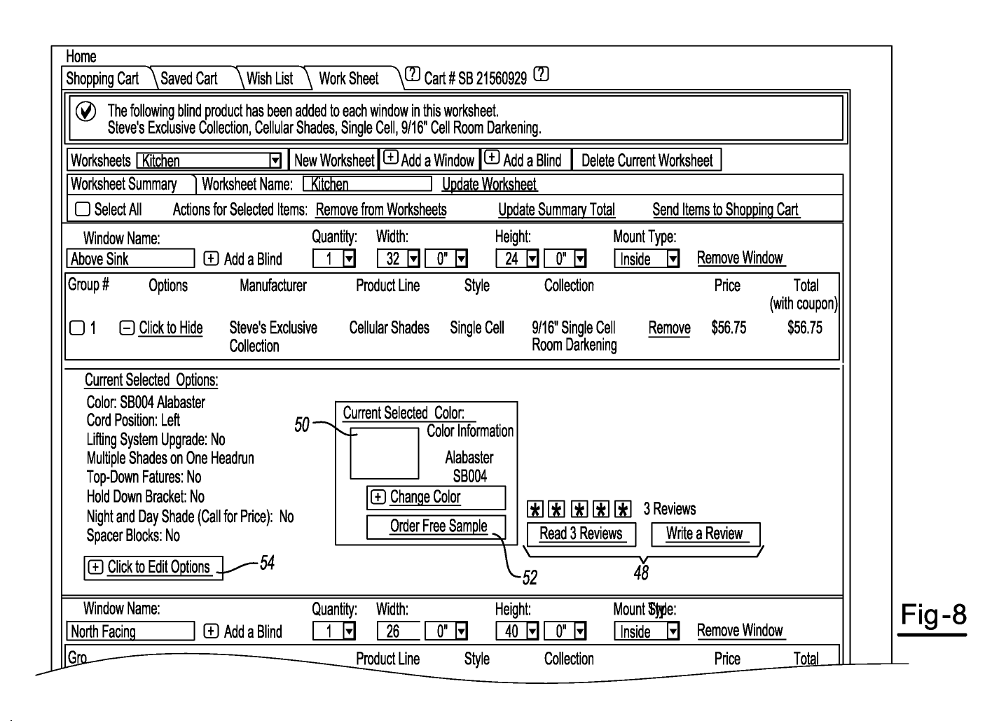

Each set of values selected for one or more variables in the product selection zone will include an options listing 46 as depicted in FIG. 7. FIG. 8 shows an expanded view of the options listing 46. The options listing 46 may include default settings or may require input for each option. The options listing may include a review link 48 for reading and/or writing a product review. The options listing 46 may include a color swatch 50. The options listing 46 may further include a sample link 52 for ordering a sample of the selected product.

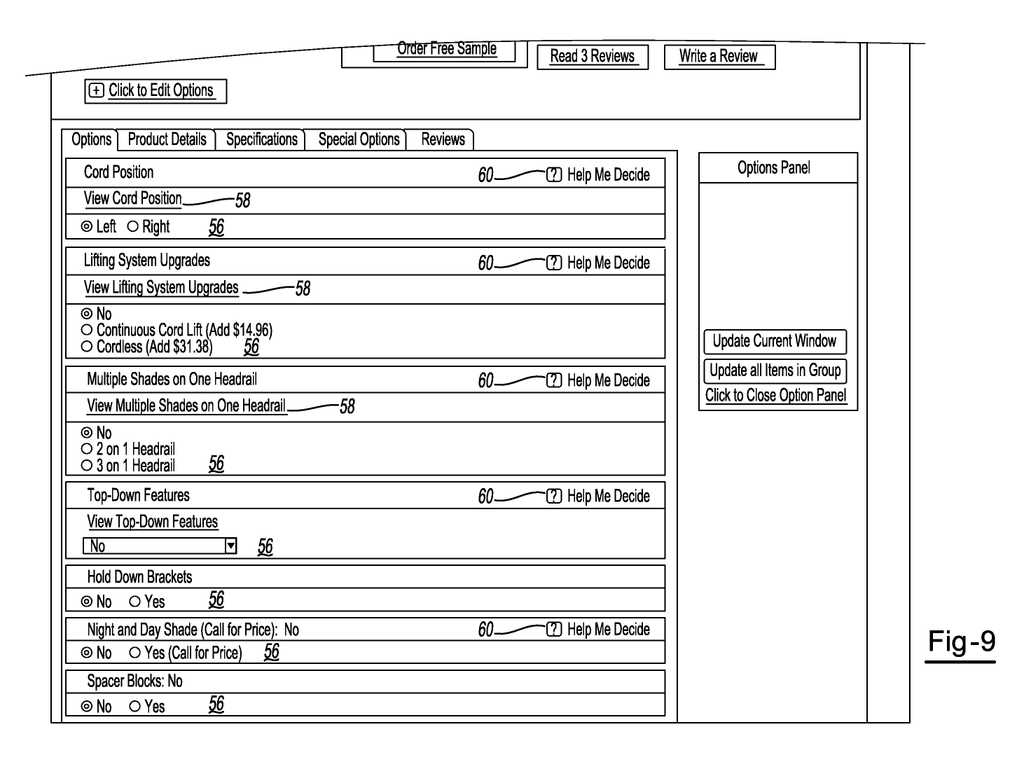

As can be seen from FIG. 8, the options listing 46 may be accessed for editing by selecting a designated options editing field 54. Upon access, details of each option may be available for viewing and/or editing. As shown for example in FIG. 9, each option 56 listed within the expanded view of the options listing may be shown having one or more distinct values that may be selected. Certain examples of such options 56 include cord position, lifting system, multiple shades per headrail, top down features, hold down brackets, night and day shades, and spacer blocks (each of which are shown at FIG. 9). The availability of each of these options for modification may depend upon those values selected for the product selection zone. As an example, certain products, styles or collections may not be available with certain lifting systems. One or more of the options 56 may include option detail links 58. These option detail links may include photos and/or instructional videos that provide a user with information to aid in selecting a value for each option 56. As one example, the top-down features option may include an option detail link 58 that includes a video depicting the use of a top-down feature. Each option 56 may also include access to help details 60 to clarify the values from which a user must select.

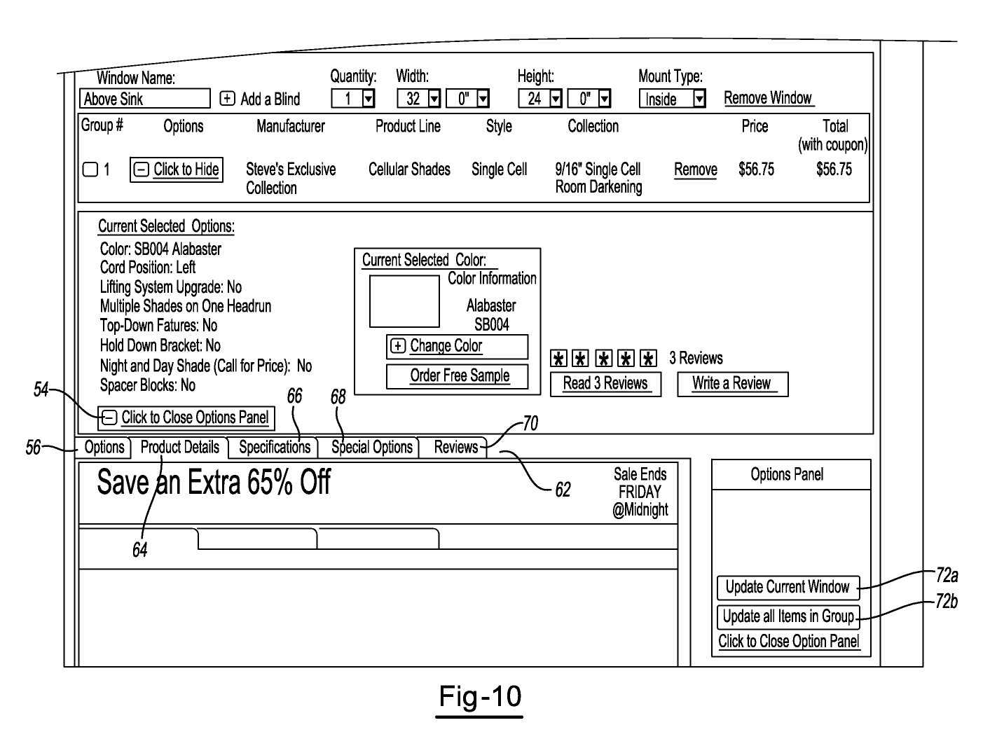

Upon access to the options editing field 54, additional product information may be accessed via the options panel 62, as shown in FIG. 10. The options panel 62 may include one or more of a product details tab 64, a specifications tab 66, a special options tab 68 and a reviews tab 70. The product details tab 64 may show available discounts for the selected product and may further describe the product. The specifications tab 66 may include limitations on the currently selected product, such limitations including maximum and minimum measurements for width and height. The special options tab 68 may include additional product attributes which may be unique to the selected product. The reviews tab 70 may include customer reviews from customers who have previously purchased the selected product. At any time during the selection or review of the values for each option 56, the user may access one or more update links 72a, 72b. The update links 72a, 72b may allow for selected options to be applied to one or more of the variables for which values for the product selection zone have been selected. As an example, in the event that a user selects a left side cord position for a first variable, but wishes to select a right side cord position for a second variable, the update link 72a may be selected so that the left side cord position is selected for only the first variable.

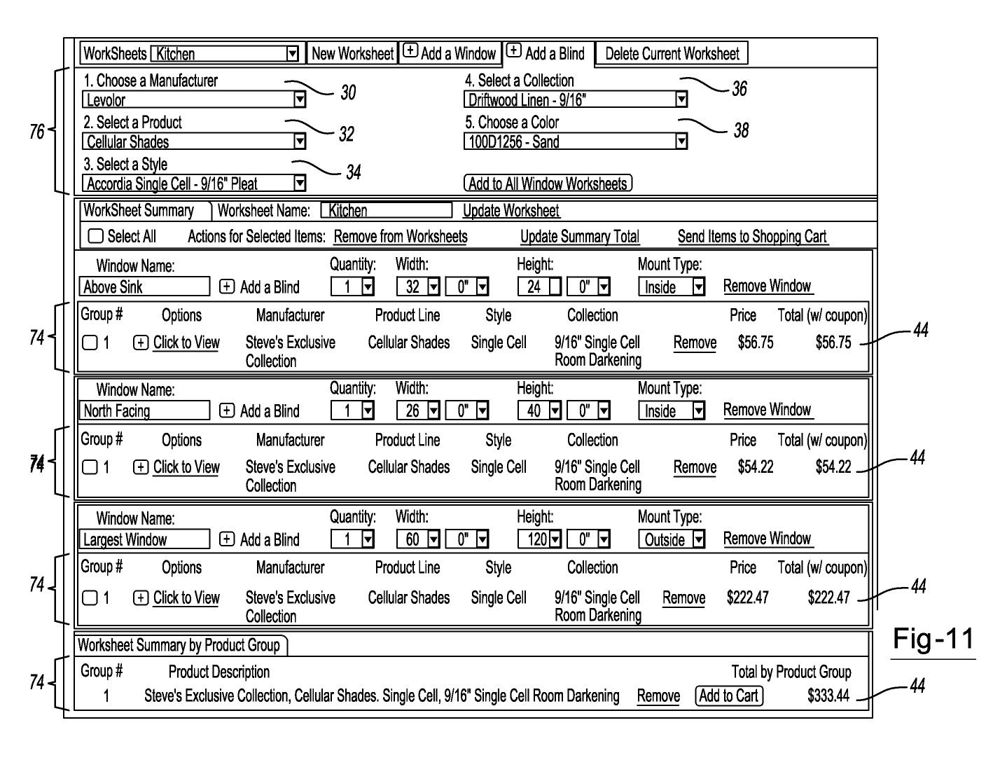

Once values have been selected for each variable in both the measurement selection zone and product selection zone, and any desired options have been selected, a user may wish to compare a cost estimate 44 for the selected values with a cost estimate for a different set of selected values. As shown in FIGS. 11 and 12, the initial selected values 74 may remain within the worksheet with no need to remove the initial selected values. To add a second (or latter) set of selected values 76, values can be selected for all variables (as shown in FIG. 11), or alternatively, values can be selected for one or more variables on an individual basis. FIG. 11 depicts second selected values 76 for each of the manufacturer identifier 30, the product identifier 32, the style identifier 34, the collection identifier 36, and the color identifier 38. At FIG. 12, the second selected values 76 are included with each variable 12 below the initial selected values 74. As a result, the cost estimates can be compared on a per variable basis 44a or within the product group summary 44b. As with selection of the initial selected values 74, the second selected values may be selected on a per variable basis (e.g., a different set of values for each variable) or the second selected values may be selected once for all variables (e.g., identical values for each variable) as shown in FIG. 12.

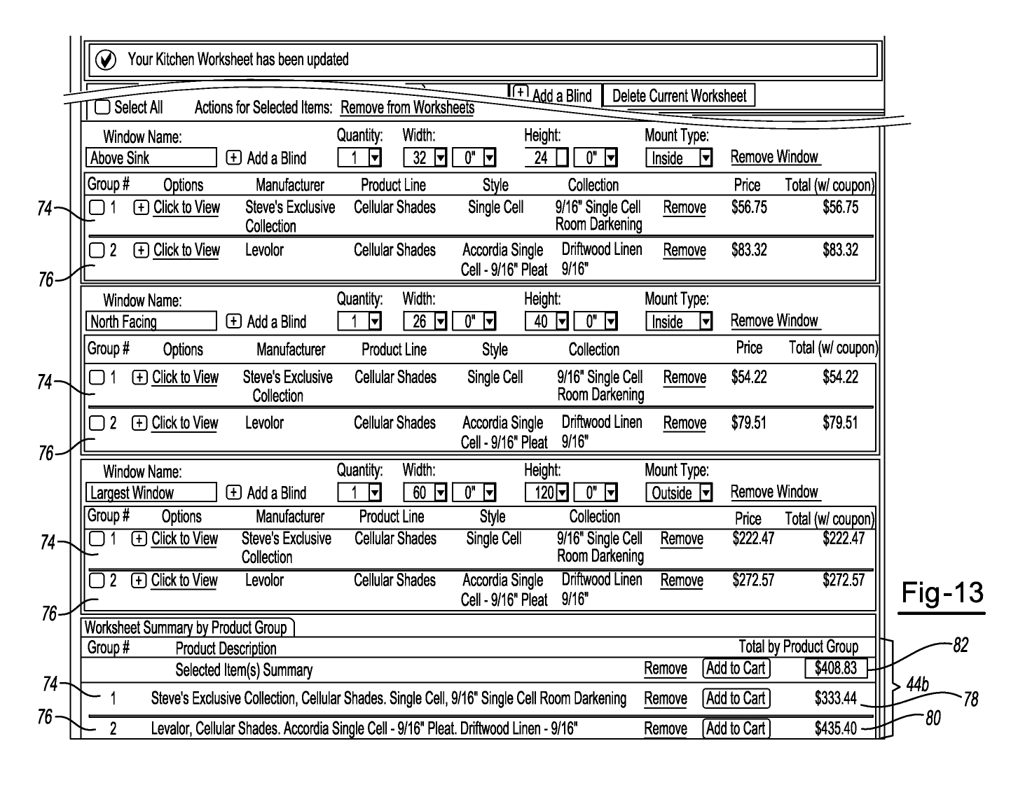

Upon selection of a plurality of values for the product selection zone, a user may have the option of choosing different values for each variable. As shown for example in FIG. 13, the initial selected values 74 have been chosen for two of the variables, whereas the second selected values 76 have been chosen for the remaining variable. As also shown in FIG. 13, the cost estimates shown in the product group summary 44b may include not only cost estimates for the initial selected values 78, and cost estimates for the second selected values 80, but also cost estimates for the chosen values 82 (e.g., the initial selected values for two variables and the second selected values for one variable). In the event that the user selects different values per variable, an update link 84 may be included so that cost estimate for the chosen values 82 includes the selected values. A cart link 86 may also be included so that the values selected for each variable can be copied to a shopping cart location. Preferably, upon copying the selected values for each variable to the shopping cart location, the selected values will still remain in the worksheet as well.

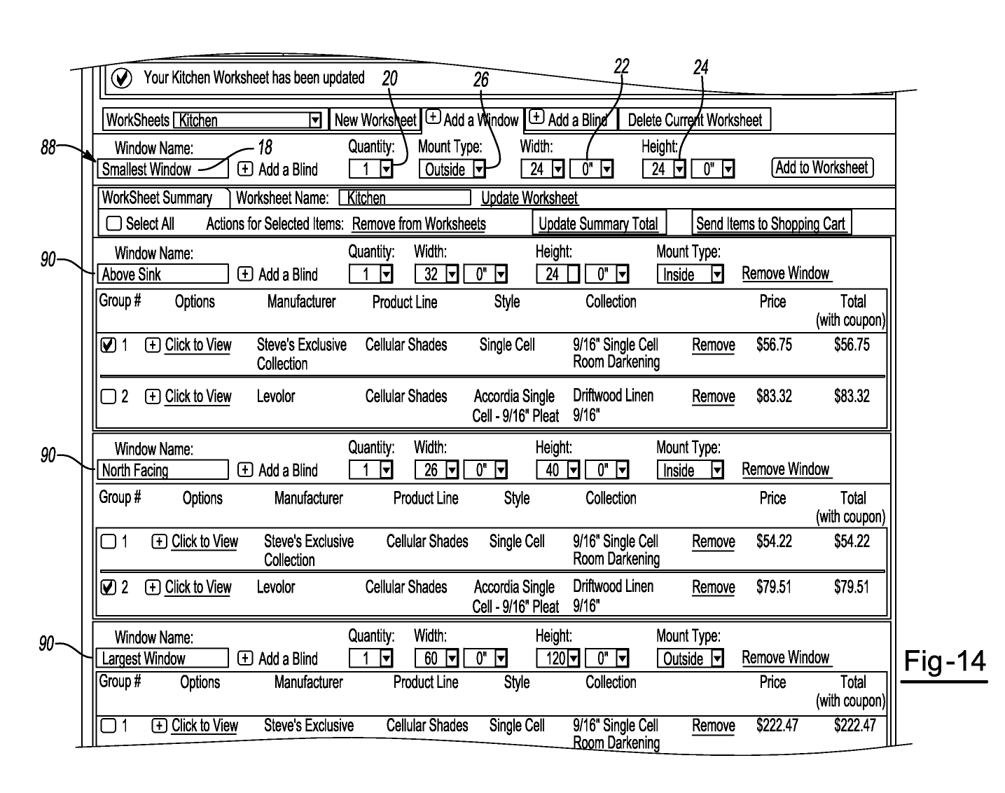

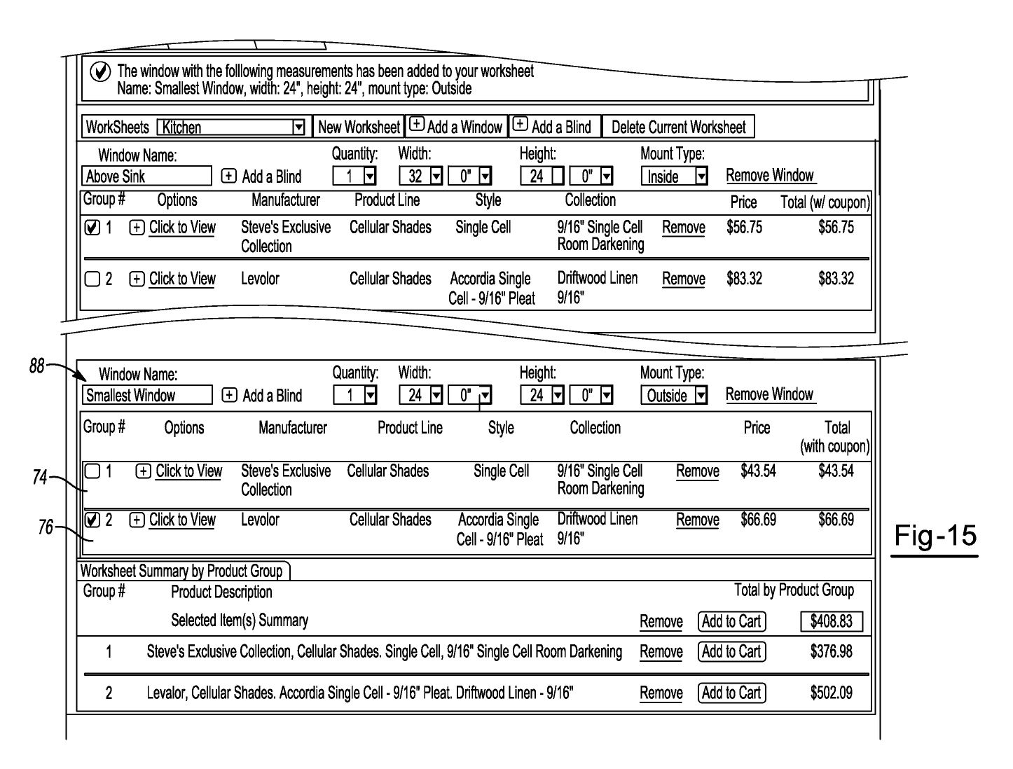

At any time, a user may choose to add additional variables for which products may be selected. FIG. 14 shows the addition of a secondary variable 88 labeled “Smallest Window” after complete values have been selected for the original variables 90. The addition of the secondary variable 88 may require selection of values for one or more of the item identifier 18, quantity identifier 20, width identifier 22, height identifier 24 and mount identifier 26. Upon addition of the secondary variable 88, the secondary variable may have any values previously selected for the original variables 90 automatically selected as shown in FIG. 15. In accordance with the example at FIG. 15, the initial selected values 74 for the product selection zone and the second selected values 76 for the product selection zone have both been automatically selected for the secondary variable 88.

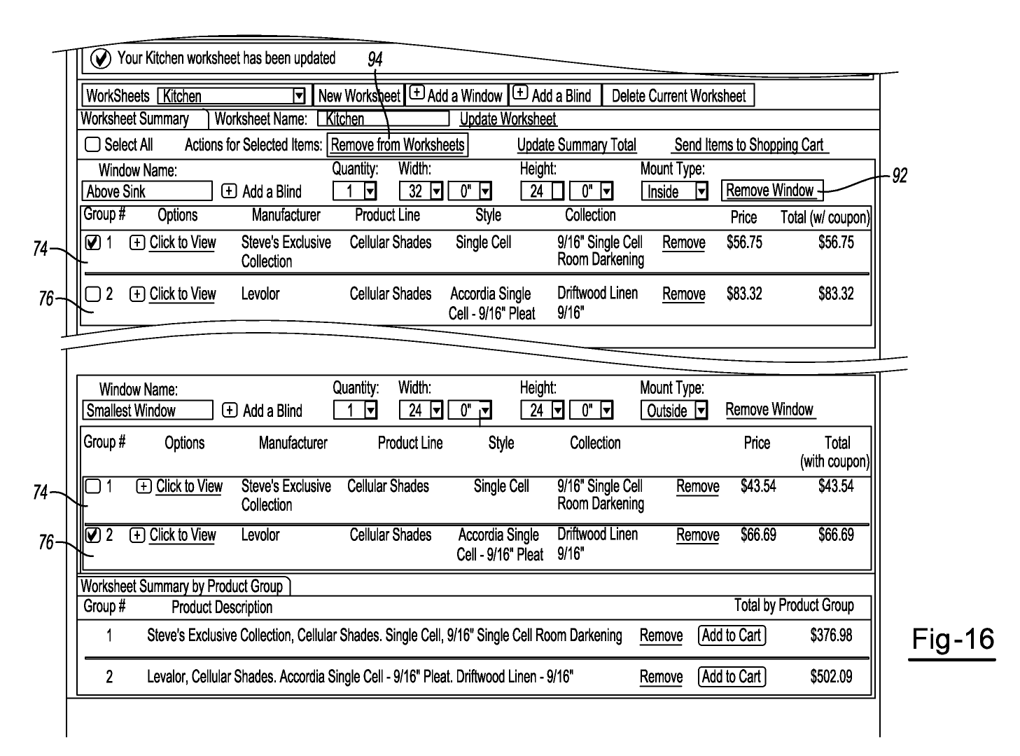

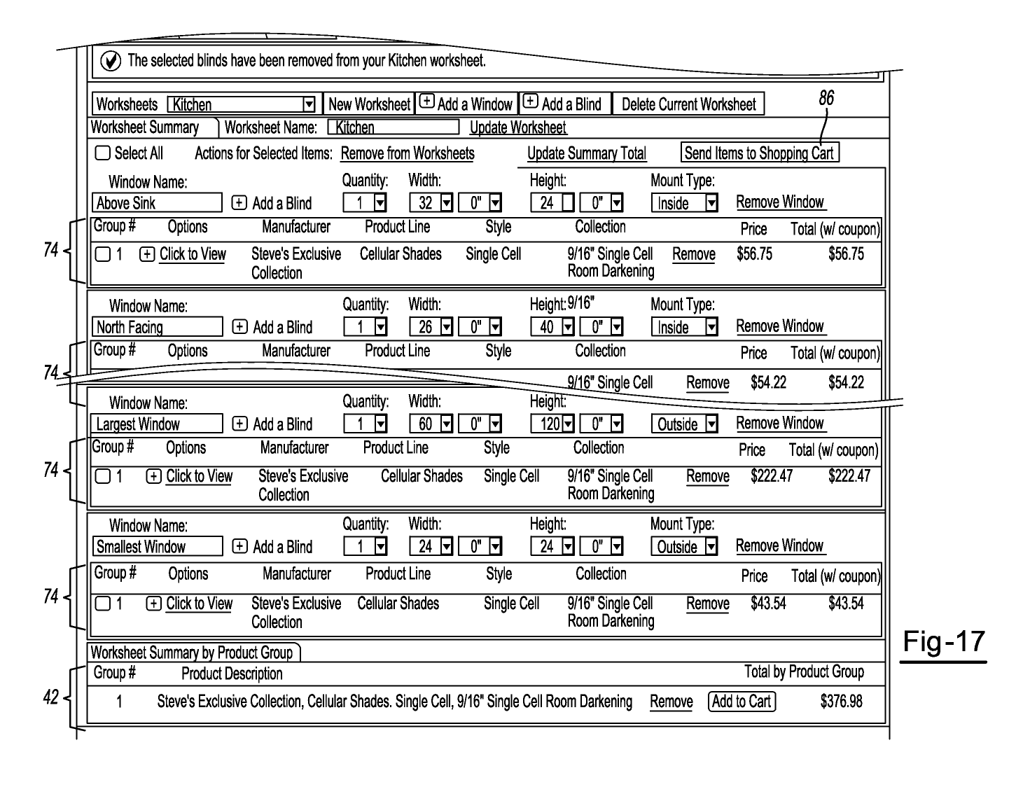

As identified above, the system disclosed herein includes means for the addition of variables and values at any time during the selection process. The system also includes means for removal of variables and/or values at any time during the selection process. FIG. 16 shows both a variable removal link 92 and a product removal link 94. More specifically, FIG. 16 shows the second selected values 76 being selected for removal from the worksheet by means of the product removal link 94. As shown in FIG. 17, once the second selected values 76 have been removed, only the initial selected values 74 remain. As further shown in FIG. 17, the product group summary 42 may also reflect removal of the second selected values 76.

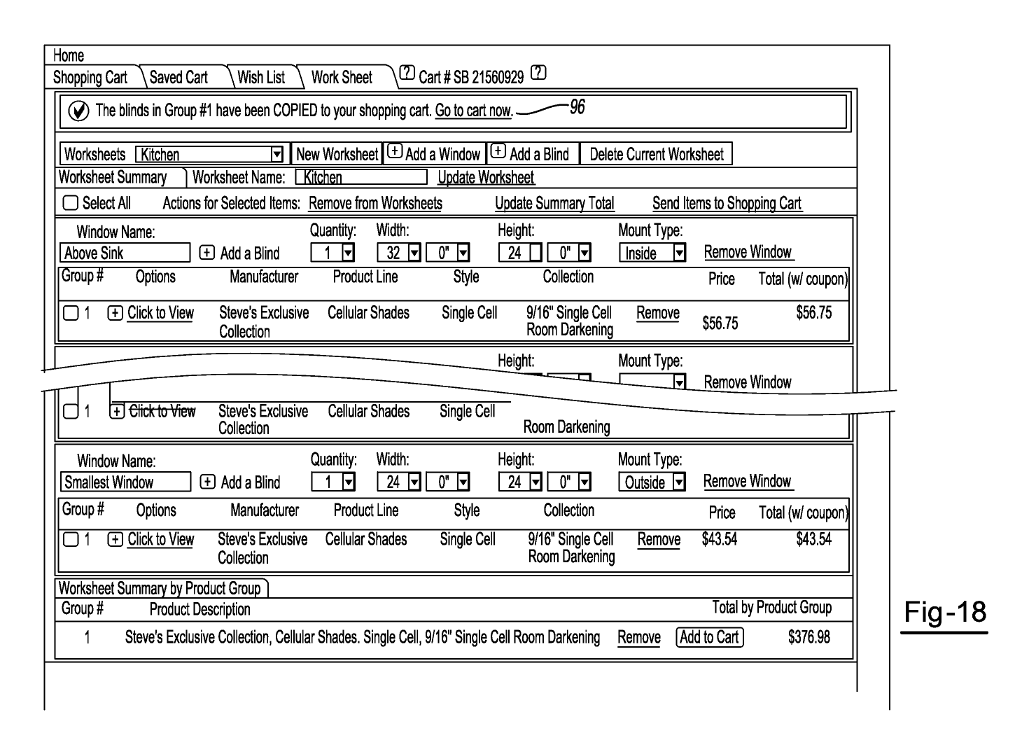

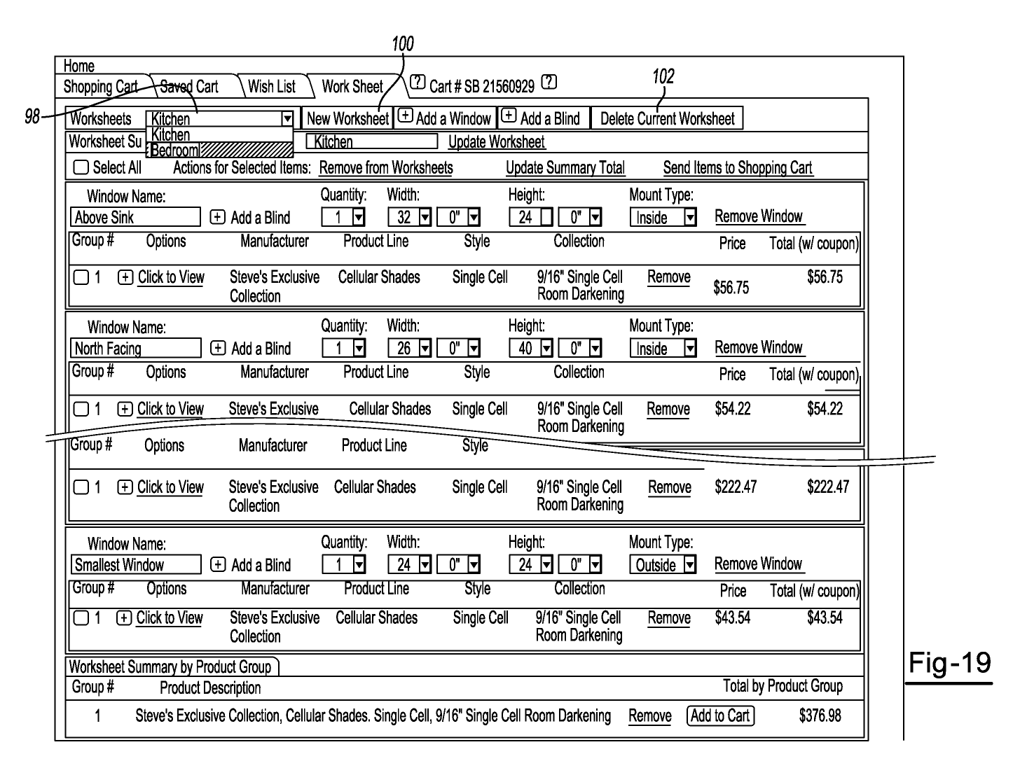

Upon copying of selected products to the shopping cart location via the cart link 86 as shown in FIG. 17, a cart access link 96 may then be shown on the worksheet, as depicted in FIG. 18. FIG. 19 shows the availability of a switch menu 98 which allows a user to access multiple worksheets and to navigate between the worksheets by selecting the desired worksheet from the switch menu 98. In addition, at any time a new worksheet can be created via a new worksheet link 100, or any worksheet can be deleted via a delete worksheet link 102.

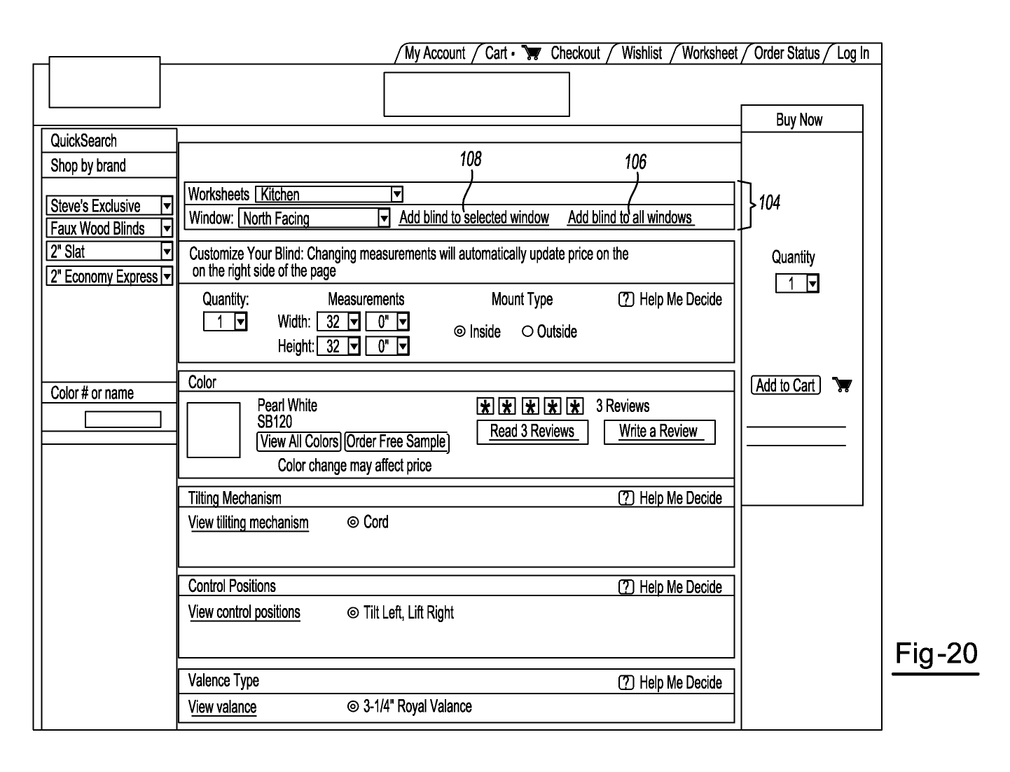

A significant benefit of the system described herein is the ability to browse standard product pages and then add a product directly from a product page to one or more variables within an existing worksheet. As shown for example at FIG. 20, upon creation of one or more worksheets, any product identified in browsing through standard product pages can be selected for one or more variables. The product may be selected for one or more variables without navigating away from the standard product page. Upon access to a standard product page, a worksheet access point 104 may be available for selecting which active worksheet the product is selected for. Further, an add to all link 106 and an add to less than all link 108 may be available so that a user may select the product for one or more of the variables identified on the worksheet.

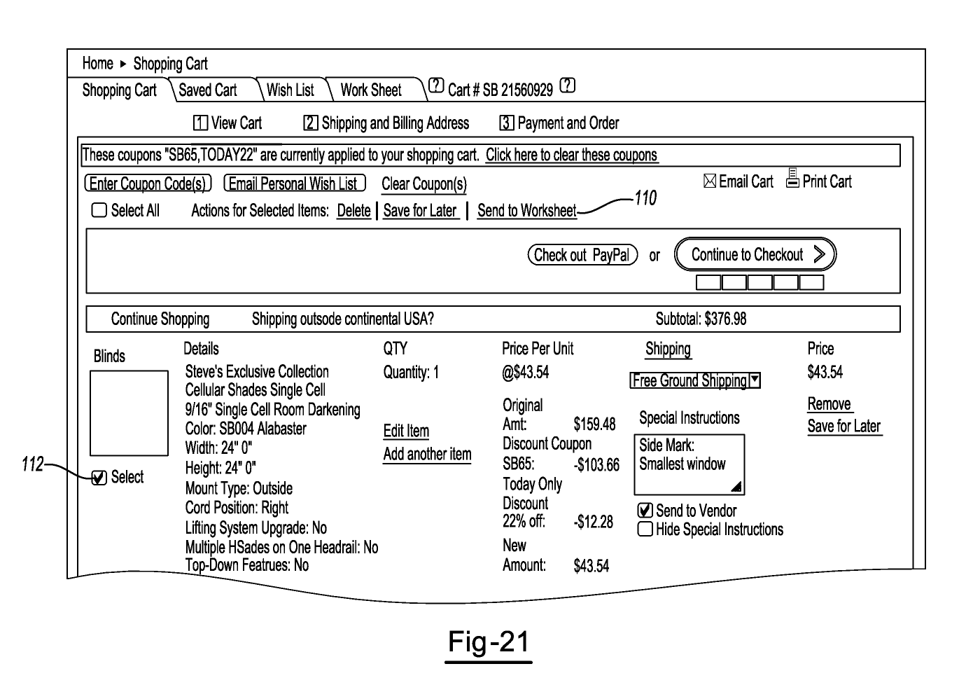

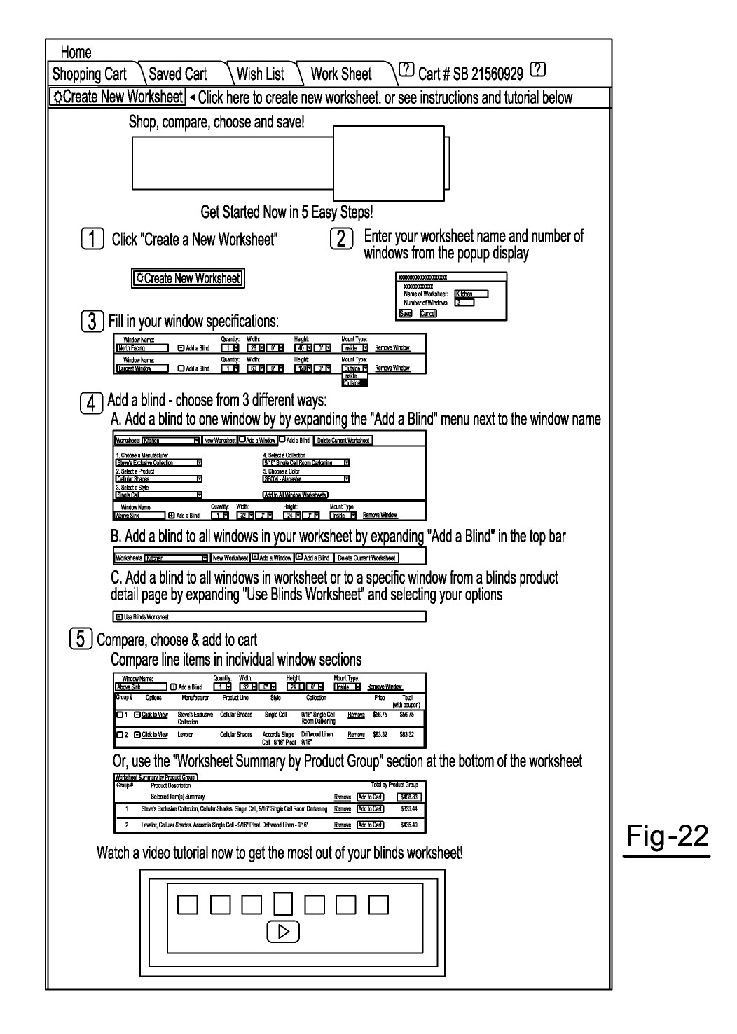

A further benefit of the system described herein is the ability to copy products directly from a cart location to an existing worksheet. As such, a user may browse standard product pages and add desired products to a cart location. Those added products may then be copied directly to an existing worksheet via a send link 110 as shown at FIG. 21. Products from the cart location that a user desires to copy to an existing worksheet can be selected via a select box 112 as also shown in FIG. 21. The system described herein may also include an instructional page as shown for example in FIG. 22. The instructional page may include visual instructions which may or may not be interactive. The instructional page may include a video instruction means which may be selected for viewing by a user.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

The preferred embodiment of the present invention has been disclosed. A person of ordinary skill in the art would realize however, that certain modifications would come within the teachings of this invention. Therefore, the following claims should be studied to determine the true scope and content of the invention.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

What is claimed is:

1. A process comprising the steps of:
a) selecting a new design plan worksheet available on a program storing a non-transitory computer readable medium;
b) accessing a first data entry point on the worksheet, wherein access to a second data entry point is prevented until:
i. a location label is provided; and
ii. a variable corresponding to the location label is provided;
c) providing the location label;
d) providing the variable value, wherein the variable value equals the number windows in a location;
e) accessing a second data entry point, wherein the second data entry point includes one or more measurement selection zones and the number of measurement selection zones is equal to the variable;
f) selecting values for each of the one or more measurement selection zones wherein each measurement selection zone includes:
i. an item identifier;
ii. a quantity identifier;
iii. a width identifier;
iv. a height identifier;
v. a mount identifier;
g) accessing a third data entry point, wherein the third data entry point includes one or more product selection zones and the number of product selection zones is equal to the variable;
h) selecting values for each of the one or more product selection zones wherein each product selection zone includes:
i. a manufacturer identifier;
ii. a model identifier;
iii. a style identifier;
iv. a collection identifier;
v. a color identifier;
i) applying the values selected for the one or more product selection zones to any number of windows;
wherein additional values for the product selection may be selected in the event that the values selected for the one or more product selection zones are not applied to all windows designated by the variable.

2. The process of claim 1, wherein the value selected for the manufacturer identifier determines the values available for selection as the model identifier.

3. The process of claim 1, wherein the value selected for the model identifier determines the values available for selection as the style identifier.

4. The process of claim 1, wherein the value selected for the style identifier determines the values available for selection as the collection identifier.

5. The process of claim 1, wherein the value selected for the collection identifier determines the values available for selection as the color identifier.

6. The process of claim 1, wherein the values available for selection as the manufacturer identifier are determined by the values selected for the width identifier, the height identifier, and the mount identifier.

7. The process of claim 1, wherein the values available for selection as the model identifier are determined by the values selected for the width identifier, the height identifier, and the mount identifier.

8. The process of claim 1, wherein the values available for selection as the style identifier are determined by the values selected for the width identifier, the height identifier, and the mount identifier.

9. The process of claim 1, wherein the values available for selection as the collection identifier are determined by the values selected for the width identifier, the height identifier, and the mount identifier.

10. The process of claim 1, wherein the values available for selection as the color identifier are determined by the values selected for the width identifier, the height identifier, and the mount identifier.

11. The process of claim 1, wherein upon selection of values for each of the width identifier, height identifier, mount identifier, manufacturer identifier, model identifier, style identifier, collection identifier, and color identifier, one or more values for an options identifier can be selected.

12. The process of claim 1, wherein upon selection of values for each of the width identifier, height identifier, mount identifier, manufacturer identifier, model identifier, style identifier, collection identifier, and color identifier, an image of a selected product sample is available for viewing.

13. The process of claim 1, wherein the values available for selection of options identifiers are selected from the group consisting of: cord position, lifting system, shades per headrail, top down features, hold down brackets, night and day shade, and spacer blocks.

14. The process of claim 1, wherein the values available for selection of options identifiers include digital images or instructional videos corresponding to one or more of the values.

15. The process of claim 1, wherein multiple values for each of the manufacturer identifier, model identifier, style identifier, collection identifier, and color identifier can be selected.

16. The process of claim 1, wherein upon entry of values for each of the manufacturer identifier, model identifier, style identifier, collection identifier, and color identifier, a cost value is available for viewing.

17. The process of claim 1, wherein upon entry of multiple values for each of the manufacturer identifier, model identifier, style identifier, collection identifier, and color identifier, multiple cost values corresponding to each selection are available for viewing.

18. The process of claim 1, wherein upon entry of multiple values for each of the manufacturer identifier, model identifier, style identifier, collection identifier, and color identifier, one or more value may be deleted for some or all of the variables.

19. The process of claim 1, wherein products having differing values for the product selection zones can be selected on a per variable basis and copied to a shopping cart location while still remaining on the design plan worksheet.

20. The process of claim 1, wherein product selection zone values can be entered from a standard product page so that the product located on the standard product page is added to one or more variables.
